(19) United States
(12) Patent Application Publication
(10) Pub. No.: US 2020/0284000 A1
(43) Pub. Date: Sep. 10, 2020

(54) WATER SAVING SYSTEM WITH A DIVERTER VALVE FOR SWITCHING COLD AND HOT WATER PASSING THERETHROUGH

(71) Applicant: Ghulam Umar, Markham (CA)

(72) Inventor: Ghulam Umar, Markham (CA)

(21) Appl. No.: 16/880,968

(22) Filed: May 21, 2020

Related U.S. Application Data
(60) Provisional application No. 62/852,267, filed on May 23, 2019.

(51) Int. Cl. E03C 1/02; E03B 1/04

(52) U.S. Cl. CPC E03C 1/023; G05D 23/1346; E03B 1/048

(57) ABSTRACT

Presented is a water saving system that includes an auxiliary tank, a diverter valve having an inlet port that operationally connects to a preexisting pipeline system to draw water restrained or flowing through the pipeline system, a first outlet port that operationally connects to the auxiliary tank using a pipe for storage of water, and a second outlet port that operationally connects to an ablutionary installation such as a shower head for showering. The system further includes a thermostat element disposed within the valve body, and a temperature adjuster rotatably configured in the valve body that enables a user to set a specific temperature based on which the diverter valve can switch the flow of water arriving from the preexisting pipeline system to either the first outlet port for storage in the auxiliary tank, or the second outlet port for showering via the shower head.

### CROSS-REFERENCE TO RELATED PATENT DOCUMENTS

This patent application claims the benefit of priority of U.S. Provisional Application No. 62/852,267 entitled “DIVERTER VALVE FOR SWITCHING FLOW OF COLD AND HOT WATER THROUGH ABLUTIONARY INSTALLATIONS SUCH AS SHOWER HEADS,” filed May 23, 2019, which is hereby incorporated herein by reference in its entirety.

### FIELD OF THE INVENTION

The present disclosure relates to valves for controlling fluid flow, and particularly to a diverter valve that can be integrated with ablutionary installations such as shower heads and the like for switching flow of cold and hot water.

### BACKGROUND

Users require hot water for taking a shower using bath outlets; washing dishes and clothes using hand taps. In order to fulfill this requirement, often various heating sources such as geysers are installed in bathrooms or other remote places. These heating sources heat cold water to a desired temperature, and transmit the heated water for uses to ablutionary installations such as showers, faucets via Thermostatic Mixing Valve (TMV) using preinstalled pipeline system. As known, the TMV is a mechanism that blends hot water with cold water at a pre-set temperature to ensure that when the water is released through this valve and into the water system for delivery to taps, bath outlets, or other outlets where the water is directly accessible to a user, the water is delivered at a certain temperature.

It is known fact that, there always remains some water in the preinstalled pipeline system and is usually cold and has an ambient temperature nearly equivalent to atmospheric temperature outside. For the users who desire to have hot water, the temperature of the water in the pipeline system may not be acceptable and thus the users may open the faucet or water outlets to draw the hot water from the heating source. In the event, where the heating source is remotely located and the user is not using the TMV, then as the user turns on showers, faucets or other water outlets, the water that's remained in the preinstalled pipeline system first flows out of the shower heads, faucets, or other desired outlets until the hot water from the heating source reaches the desired outlets. This water with ambient temperature that usually flow out of the shower heads, faucets, or other outlets are usually wasted as the users just tend to wait for the hot water to reach and flow out of the shower heads, faucets, or other outlets and be accessible to them.

In this event, it becomes utmost important to save this water with ambient temperature that get wasted unused. While the supply of water seems abundant, water is not a limitless resource, particularly when the water is most necessary to human survival. Without any conservation efforts from users to prevent water wastage, this vital supply of water may be exhausted. With regard to this, several inventors in the past have proposed different solutions For example, U.S. Ser. No. 10/047,505 discloses cool water draining switch valve having a valve body, a valve spool and a thermal module disposed in the valve body. The valve body has an inlet passage and two outlet passages connected to the inlet passage. The patent as disclosed uses retractable ports to open/close water draining holes and it allows for the multi-way flow of water through two outlet ports. It has limitation based on its complex structural design.

U.S. Ser. No. 10/012,320 discloses a hot and cold water switching valve that operates in two modes and can flexibly control the hot water outflow while avoiding the waste of cold water. The valve as disclosed in the patent uses three switching elements configured within the valve's body. The claimed water switching valve requires a user to turn a knob that changes the direction of the water flow through the valve. During the summer, or when no hot water is required, this allows the water to flow freely from the water source. However, during the winter, or when hot water is required, the ambient-temperature water flows to a “recovery channel”. As disclosed, the knob is used to control a switching valve's positioning to determine whether hot water is required. Additionally, a thermostat body with a spring, O-shaped sealing rings, and limiting plates is used to control the flow of water. It has limitation based on its complex structural design.

U.S. Pat. No. 5,165,456 discloses a two-way diverter valve having a valve body that includes an inlet port, a first outlet port and a second outlet port. The inlet port is separated from the two outlet ports. There is also provided a rotatable valve with a knob for rotating the valve stem to selectively divert the fresh water from outlet neck to either the first outlet port or the second outlet port by way of respective valve passages. The patent discloses a manual diverter valve, manually operable by a user to allow storage of cold water from the hot water line in an auxiliary tank. While such an arrangement can save water, it has limitations based on the manual operation. Such an arrangement relies on the individual operator to initiate the savings of water. This is not convenient and may not be reliable depending upon the number of potential users.

U.S. Pat. No. 4,854,499 discloses a temperature sensitive shower diverter valve and method for diverting shower water used between a source of shower water and a shower head to control the flow of water to the shower head. The diverter valve is positioned between the wall outlet pipe and the shower head. The valve as described in the patent diverts the water from a bather when the temperature of the water is too hot or too cold and automatically resets when water of the proper temperature arrives. As can be understood from the patent, the outlet port that diverts ambient temperature water simply shoots into a corner or against the shower wall. The purpose is to ensure the user gets their desired temperature, but not necessarily to save the diverted water. The patent further discloses use of a microprocessor controller connected to a keypad to determine desired temperatures. Although the diverter valve disclosed in the patent may be satisfactory in use, apparently the patent doesn't disclose about any user friendly way to set the water temperature.

U.S. Pat. No. 7,114,661 discloses a control valve that is a three-way direction control valve that shifts when fluid passing through the valve reaches a preset temperature. The control valve includes three ports, an internal shiftable spool, and a thermal element, wherein fluid entering a first port from a source of heated fluid passes around a thermal element and out of a second port, until the fluid is warm enough to cause the thermal element to expand, thereby shifting the spool so that the first port is closed, and the second and third ports are in fluid communication with each other. The valve uses an elastomer or a material that can expand and contract with changes in temperature to change the flow of liquids. This elastomer element pushes a valve spool to block the flow of hot water from being re-directed. Although the control valve disclosed in the patent may be satisfactory in use, apparently the patent doesn't disclose about any user friendly way to set the water temperature. Further, the proposed control valve in the patent as disclosed is integrated away from ablutionary installations.

U.S. Pat. No. 5,564,462 discloses a temperature controlled system which includes a water conservation by-pass circuit. As taught by this patent, the disclosed diverter valve uses an electromagnet to change the flow of water. The patent discloses an extensive pipeline system that makes a closed plumbing system.

U.S. Pat. No. 4,554,688 discloses an apparatus for preventing the waste of water which typically occurs in household and industry installations. As disclosed in the patent, the diverted water goes to a pump that recycles the water back through the pipe system. The disclosed solution appears to be more extensive pipeline that allows diverted water to be pumped back into the system when the water reaches a desired temperature.

Although attempts are made in the past to provide various systems and/or control valves to overcome the wastage of ambient water from the pre-installed water pipeline system during showering, washing dishes and clothes, the existing systems and/or valves are either expensive, involve complex interior designs, operation, and unreliable. Thus, there remains a need for a more simplified and reliable solution to this existing problem of wastage of ambient temperature water remained in the preinstalled pipeline system.

### BRIEF SUMMARY

Accordingly, the proposed invention provides a diverter valve that can help in saving water while showering, washing dishes and clothes and so on.

It is an objective of the present invention to provide a valve that has simplified interior design, simple to operate, easy to install with the ablutionary installations such as shower heads, faucets, and at the same time cost effective to manufacture.

It is another objective of the present invention to provide a diverter valve that switches flow of cold and hot water passing through the ablutionary installations based on a specific temperature of the water set by a user.

It is another objective of the present invention to provide a water saving system that comprises of a diverter valve connected in midway between an ablutionary installation (such as shower head) and the preexisting pipeline system to switch flow of cold water present in the pipeline system to an auxiliary tank for storage until the water of a desired temperature from the heating source arrives at the diverter valve that then switches the hot water through the shower head for showering.

Another objective of the present invention is to provide a water saving system which enables storage of cold water (water with ambient temperature that usually gets wasted before a user receives water with desired temperature) in an auxiliary tank that can then be used for several other domestic uses such as for watering plants, flushing toilets and so on.

According to the embodiments of the present invention, there is provided a water saving system that includes an auxiliary tank, a diverter valve comprising a valve body having an inlet port, a first outlet port, and a second outlet port, wherein the inlet port of the diverter valve in a fluid communication to a preexisting pipeline system to draw water therefrom, the first outlet port of the diverter valve in fluid communication to the auxiliary tank using a pipe, and the second outlet port of the diverter valve in fluid communication to an ablutionary installation such as shower head.

According to the embodiment, the diverter valve further includes a thermostat element disposed within the valve body perpendicularly aligned with respect to the first and second outlet ports, and a temperature adjuster rotatably configured over a threaded end opposite to the inlet port of the valve body, wherein the temperature adjuster enables a user to set a specific temperature based on which the diverter valve would switch the flow of water arriving from the preexisting pipeline system to either the first outlet port for storage in the auxiliary tank, or the second outlet port for delivery to the user through the ablutionary installation.

These and other features and advantages of the invention will become apparent from the detailed description below, in light of the accompanying drawings.

### BRIEF DESCRIPTION OF THE ACCOMPANYING DRAWINGS

FIG. 1 shows an environmental diagram of a water saving system with a diverter valve integrated with a shower head, in accordance with an embodiment of the present invention.

FIG. 2 shows an external view of a diverter valve having an inlet port, two outlet ports, union nuts, and tailpieces connected to the ports, in accordance with an embodiment of the present invention.

FIG. 3 shows a cross sectional view of the diverter valve with no union nuts, and tailpieces connected to the ports, in accordance with an embodiment of the present invention.

FIG. 4-5 shows operation of the diverter valve or switching of water flow between the two outlet ports of the diverter valve for saving ambient water remained in the pipeline system, in accordance with an embodiment of the present invention.

### DETAILED DESCRIPTION

As used in the specification and claims, the singular forms “a”, “an” and “the” include plural references unless the context clearly dictates otherwise. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. References to “one embodiment”, “an embodiment”, “another embodiment”, “an example”, “one implementation”, “some embodiment”, and so on, indicate that the embodiment(s) or example(s) so described may include a particular feature, structure, characteristic, property, element, or limitation, but that not every embodiment or example necessarily includes that particular feature, structure, characteristic, property, element or limitation. Unless stated otherwise, terms such as “first”, “second”, are used to arbitrarily distinguish between the elements such terms describe. Thus, these terms are not necessarily intended to indicate temporal or other prioritization of such elements. In the context of the present invention, the terms “cold water”, “water with ambient temperature”, “ambient temperature water”, and so on all mean the same and used to refer to the stored water or water remained in the pipeline system that is nearly equal in temperature to the outside environment. These terms are interchangeably used in this disclosure.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

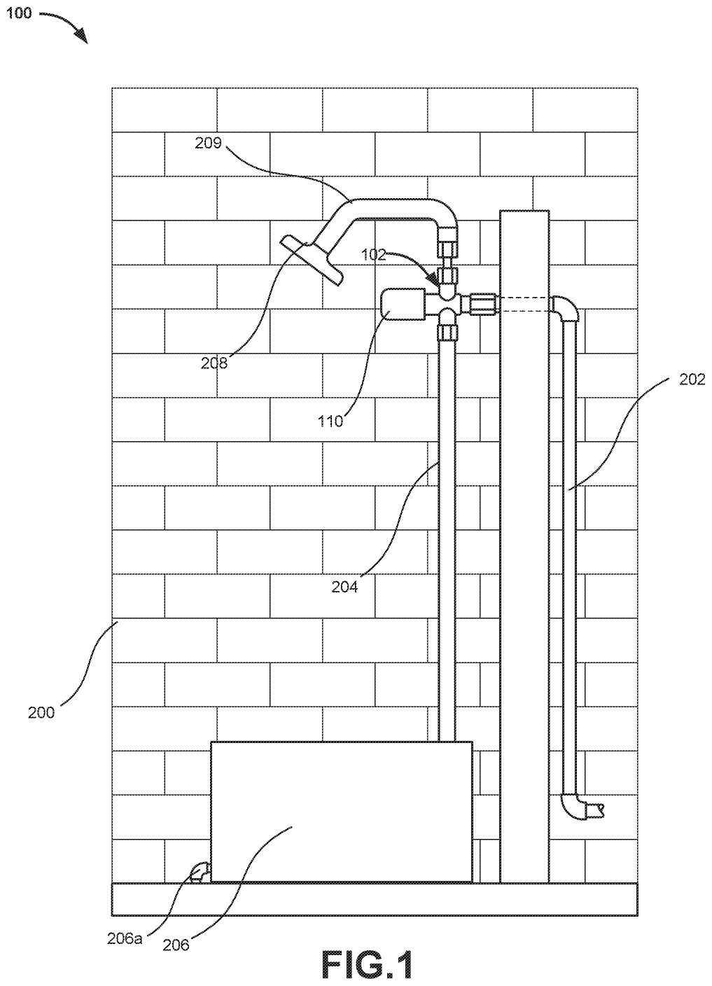

The diverter valve that can be integrated with ablutionary installations such as shower heads and the like for switching flow of cold and hot water in order to save or store the water with ambient temperature (or water below desired temperature) that would otherwise be wasted or go unused will now be described with reference to the accompanying drawings FIGS. 1-5, which should be regarded as merely illustrative without restricting the scope and ambit of the disclosure.

Referring to accompanying figures, particularly to FIG. 1, an environmental diagram of a water saving system with a diverter valve integrated with a shower head is shown, in accordance with an embodiment of the present invention. Although, not explicitly shown, it should be understood that some heating source (such as a portable geyser) may be connected to a water supply source so that hot water can be delivered to a user through various outlets when needed.

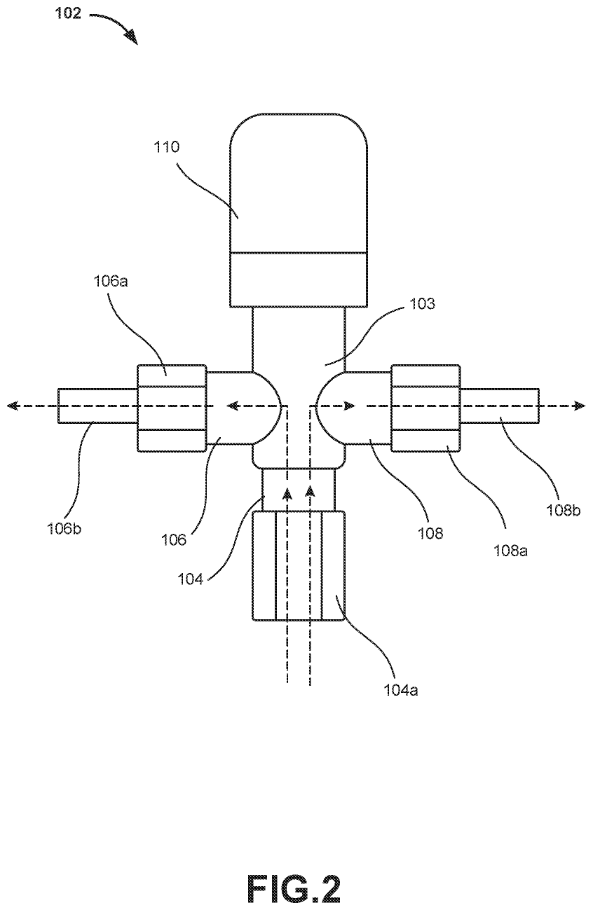

The water saving system 100 is shown installed in a washroom/bathroom 200. Typically, the washroom/bathroom 200 includes a preexisting pipeline system or water line 202 usually distributed and concealed within walls of the bathroom 200. Typically, the preexisting pipeline system 202 concealed within the walls are provided with multiple ablutionary installations (bath shower heads, hand taps and so on) installed at different locations within the bathroom 200. The various ablutionary may be installed to enable a user to receive the water therefrom that passes through the preexisting pipeline system 202 for various purposes such as for washing clothes, taking shower and so on. As seen, the system 100 further includes a diverter valve 102 configured in between a shower head 208 and the preexisting pipeline 202. In particular, the shower head 208 connects to an outlet port of the diverter valve 102 using a shower arm 209. As seen, an inlet port of the diverter valve 102 connects to an outlet present on bathroom wall that's in fluid communication with the preexisting pipeline system 202 concealed within the bathroom's wall. The diverter valve 102 is further connected to an auxiliary tank 206. The tank 206 may be made of various materials such as for example, plastic. Further, the size/capacity of the tank 206 can vary based on the requirement. In the example, the auxiliary tank 206 is shown installed within the bathroom 200, but it can be understood that the auxiliary tank 206 may be installed at any other location in the residence or outside the residence. Particularly, an outlet port of the diverter valve 102 is connected to the auxiliary tank 206 using a pipe 204. The pipe 204 may be any commercially available pipe that can connect to the outlet port. As seen, the auxiliary tank 206 may further include an outlet 206a that may be selectively opened or closed to drain water stored in the auxiliary tank 206 to other places for various purposes such as for example but not limited to flushing toilets, washing hands, watering plants and so on. Further, the diverter valve 102 includes a temperature adjuster 110. The temperature adjuster 110 enables a user to set a specific temperature based on which the diverter valve 102 may switch the flow of water arriving from the preexisting pipeline system 202 to one of the provided two outlet ports either for storage of ambient temperature water in the auxiliary tank 206, or desired hot water from heating source for showering. A more comprehensive detail on the design features, and functionalities of the diverter valve 102 of the present invention is presented in FIGS. 2-5.

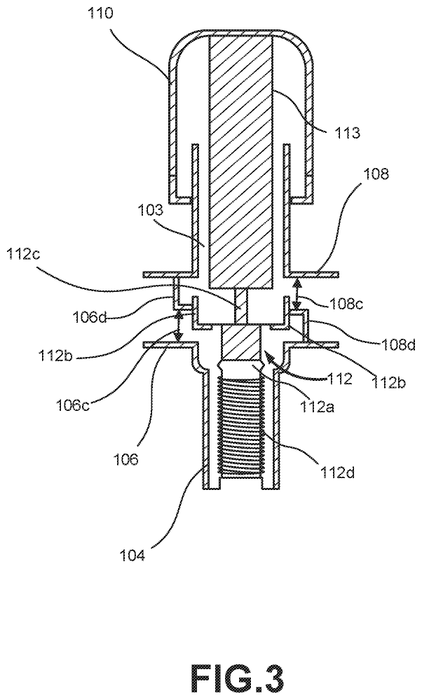

Referring to FIGS. 2-3, the diverter valve 102 includes a valve body 103. The valve body 103 includes an inlet port 104, a first outlet port 106, and a second outlet port 108. As seen, the first and second outlet ports 106,108 are configured opposite to each other. Also, as seen, the valve body 103 is constructed such that the first outlet port 106 is partially blocked using a member 106d, and the second outlet port 108 is partially blocked using a member 108d. As seen in the FIG. 2, the diverter valve 102 may further include union nuts or nut assemblies 104a, 106a, 108a, tail pieces 106b, 108b connected to the ports 104,106,108 in order to facilitate connectivity of the valve 102 with other plumbing structures such as the pipe 204. The diverter valve or body 103 and any other associated components thereof may be made of metallic material such for example brass. The valve 102 may be made in various sizes depending upon requirement. Further, many other components not shown and described such as but not limited to gaskets, strainers etc may be used with the proposed diverter valve like in any other known thermostatic mixing valves and are intentionally omitted from the description to keep the focus of the patent more into the novel and inventive aspects of the disclosure. Referring to FIG. 1 in conjunction to FIG. 2, the inlet port 104 of the diverter valve 102 is operationally connected to the preexisting pipeline system 202 to draw water therefrom, the first outlet port 106 of the diverter valve 102 operationally connected to the auxiliary tank 206 using the pipe 204, and the second outlet port 108 of the diverter valve 102 operationally connected to the shower head 208 using the shower arm 209. Further, it can be understood from FIG. 1 that the shower arm 209 is in fluid communication with the second outlet port 108 of the valve 102 to supply water to the shower head 208.

As seen in FIG. 3, the diverter valve 102 further includes a thermostat element 112 disposed within the valve body 103. Particularly, the thermostat element 112 is perpendicularly aligned with respect to the first and second outlet ports 106,108 of the diverter valve 102. Further as seen, the thermostat element 112 includes a thermostat body 112a preferably cylindrical in shape. The thermostat element 112 further includes a plunger 112c operationally configured at a center top end of the thermostat body 112a. The plunger 112c is configured to either retract or extend based on the temperature of the water passing through the valve body 103. The thermostat element 112 further includes a cylinder 112b preferably cylindrical in shape configured over the top end of the thermostat body 112a surrounding the plunger 112c. The cylinder 112b preferably attaches to or sits on periphery at the top end of the thermostat body 112a such that the cylinder moves along with the movement of the thermostat body 112a. The movement of the cylinder 112b is against the members 106d, 108d. The movement of the cylinder 112b selectively opens openings 106c, 108c of the first and second outlet ports 106,108. The cylinder 112b is made up of but not limited to plastic, rubber or any other like materials known in the art. As seen, a portion of the thermostat body 112a may be wrapped within a spring 112d or in simple terms the thermostat body 112a is embodied within or surrounded by the spring 112d. The spring 112d may be made of stainless steel or like elastic material. The spring 112d is preferably a compression spring capable of expansion (stretchable) or compression.

The diverter valve 102 further includes a temperature adjuster 110 rotatably configured over a threaded end 113 opposite to the inlet port 104 of the valve body 103. The adjuster 110 may be made of various materials such as stainless steel, plastic and so on. The adjustable range can vary based on application area. In an example, the adjustable range of the temperature adjuster 110 may be from 35° C.-50° C. In one example implementation, the adjuster 110 may be internally threaded to facilitate the adjuster 110 to connect to the threaded end 113 of the valve body 103. In an implementation, the adjuster 110 sits on threads, like a bolt. When the user turns it, it moves up or down changing the position where the plunger 112c touches it. So moving the adjuster 110 up moves the thermostat element 112 up, and then the plunger 112c has to move further to change outlets 106,108. The temperature adjuster 110 enables a user to set a specific temperature based on which the diverter valve 102 switches the flow of water arriving from the preexisting pipeline system 202 either to the first outlet port 106 for storage in the auxiliary tank 206, or the second outlet port 108 for showering.

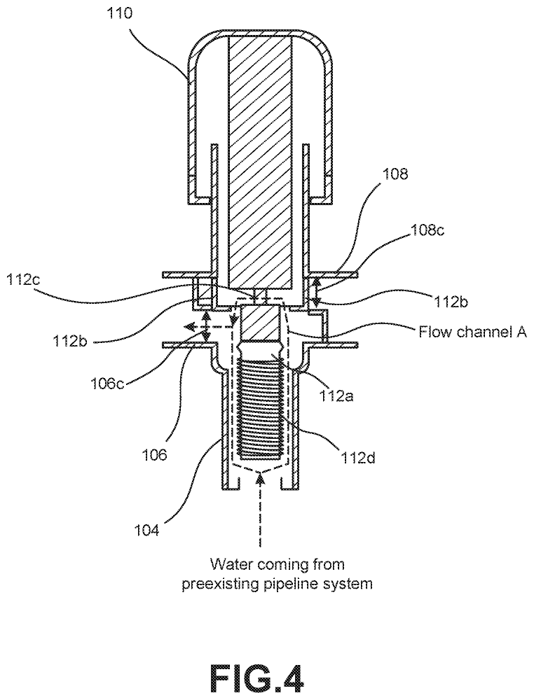

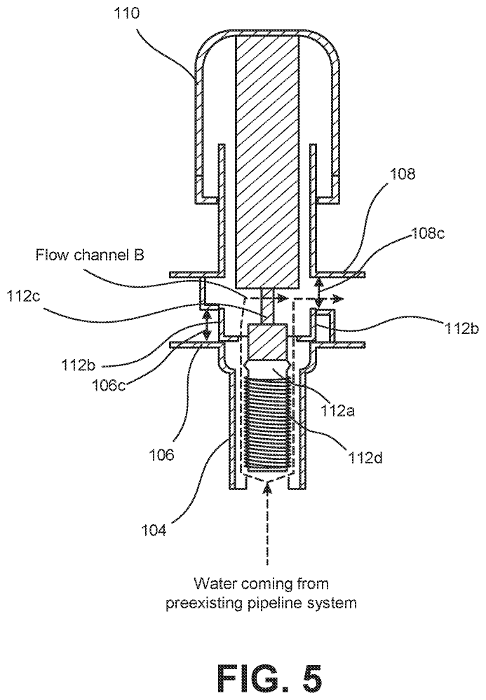

In operation, as best understood from FIGS. 4-5 in conjunction with FIG. 1, assuming the user sets (using the adjuster 110) a specific temperature (say for example 39 Degrees Celsius) for the valve 102 to perform switching between cold and hot water. When the user first opens up a knob/handle (not seen) associated with the shower head 208 for taking the shower, as a matter of fact initially the water that's present in the preexisting pipeline system/water line 202 first arrives to the valve 102 before arrival of hot water from the heating source. It is known fact that, the water that remains in the pipeline system 202 for a certain time achieves an ambient temperature or temperature substantially equal to the environment temperature. When this water present in the pipeline system 202 arrives inside the valve body 103 through the inlet port 104, the thermostat element 112 will detect if the temperature of the water is below the set temperature (<39 Degrees Celsius) or equal to or above the set temperature (>=39 Degrees Celsius). If the thermostat element 112 detect the temperature of water to be below the set temperature by the user, the plunger 112c of the thermostat element 112 would retract to push the thermostat body 112a in vertically upward direction (this is facilitated by the spring 112d) for opening a first flow channel (“Flow channel A”) represented with dotted arrow in FIG. 4. In particular, when the plunger 112c retract the cylinder 112b of the thermostat element 112 moves up, and when the cylinder 112b moves up, it lets the first outlet port 106 of the valve 102 to open. More specifically, when the cylinder 112b moves up, it just opens the opening 106c of the outlet port 106 and closes the second outlet port 108 completely (specifically the opening 108c of the outlet port 108). The water which is of lower temperature (not of desired temperature for showering) than the set temperature is then passed to the auxiliary tank 206 for storage through the pipe 204 connected to the outlet port 106. This stored water or saved water in the auxiliary tank 206 can then be used by the user for various purposes such as watering plants, flushing toilets and so on.

Once the complete water from the pipeline system 202 is passed and stored in the auxiliary tank 206. The water from the heating source will then arrive at the valve 102. Operationally, when the hot water from the heating source arrives at the valve 102 or valve body 103 through the inlet port 104 via the pipeline system 202, the thermostat element 112 will detect if the temperature of the water is below the set temperature (<39 Degrees Celsius) or equal to or above the set temperature (>=39 Degrees Celsius). If the thermostat element 112 detects the temperature of water being equal to or above the set temperature by the user, then the plunger 112c of the thermostat element 112 would extend to push the thermostat body 112a in vertically downward direction for opening a second flow channel (“Flow channel B”) represented by dotted arrow in FIG. 5. In particular, when the plunger 112c extends, the cylinder 112b of the thermostat element 112 moves down, and when the cylinder 112b moves down, it closes the first outlet port 106 of the valve 102 and open up the second outlet port 108. More specifically, when the cylinder 112b moves down, it just opens the opening 108c of the outlet port 108 and closes the outlet port 106 (specifically the opening 106c of the outlet port 106). The water which is of acceptable temperature (above or equal to the set temperature) is then passed to shower head 208 through the shower arm 209 connected to the outlet port 108 and used for taking shower by the user.

The valve of the present invention may be made of any suitable metallic material and in many different sizes. The various associated components of the valve (such as the thermostat element including cylinder, plunger etc, spring) may be made using suitable metals or plastic or any other material or any combinations thereof and in variety of dimensions or sizes as needed. The use of material should not be construed as any limitation for implementation of the present invention; however the material is desired to have good durability and at the same time is inexpensive for the production and affordability of the end users.

Although particular embodiments of the invention have been described in detail for purposes of illustration, various modifications and enhancements may be made without departing from the spirit and scope of the invention.

What is claimed is:

1. A water saving system (100), comprising:
an auxiliary tank (206);
a diverter valve (102) comprising
a valve body (103) having an inlet port (104), a first outlet port (106), and a second outlet port (108), wherein the inlet port (104) is in a fluid communication to a preexisting pipeline system (202) to draw water therefrom, the first outlet port (106) of the diverter valve (102) in fluid communication to the auxiliary tank (206) using a pipe (204), and the second outlet port (108) in fluid communication to an ablutionary installation (208);
a thermostat element (112) disposed within the valve body (103) perpendicularly aligned with respect to the first and second outlet ports (106,108); and
a temperature adjuster (110) rotatably configured over a threaded end (113) opposite to the inlet port (104) of the valve body (103), wherein the temperature adjuster (110) enables a user to set a specific temperature based on which the diverter valve (102) would switch the flow of water arriving from the preexisting pipeline system (202) to either the first outlet port (106) for storage in the auxiliary tank (206), or the second outlet port (108) for delivery to the user through the ablutionary installation (208).

2. The water saving system (100) of claim 1, wherein the thermostat element (112) further comprising:
a thermostat body (112a) wrapped by a spring (112d);
a plunger (112c) operationally configured on a top end of the thermostat body (112a) to either retract or extend based on the temperature of the water passing through the valve body (103); and
a cylinder (112b) configured on the top end of the thermostat body (112a) surrounding the plunger (112c) such as to move along with the movement of the thermostat body (112a).

3. The water saving system (100) of claim 1, wherein when temperature of the water arriving from the preexisting pipeline system (202) to the diverter valve (102) is detected to be below the set specific temperature, the diverter valve (102) allows the arriving water to flow through a first flow channel (“Flow Channel A”) within the valve body (103) and out to the auxiliary tank (206) through the pipe (204) for storage.

4. The water saving system (100) of claim 3, wherein when the temperature of the water arriving from the preexisting pipeline system (202) to the diverter valve (102) is below the specific temperature, the plunger (112c) of the thermostat element (112) retracts to push the thermostat body (112a) in vertically upward direction to open a first opening (106c) of the first outlet port (106) and allow the water from the valve body (103) to flow out therefrom.

5. The water saving system (100) of claim 4, wherein the first opening (106c) is opened as a result of the movement of the cylinder (112a) attached to the thermostat body (112a).

6. The water saving system (100) of claim 4, wherein the opening of the first opening (106c) of the first outlet port (106) by pushing the thermostat body (112a) in vertically upward direction is facilitated by expansion of the spring (112d).

7. The water saving system (100) of claim 1, wherein when temperature of the water arriving from the preexisting pipeline system (202) to the diverter valve (102) is equal to or above the set specific temperature, the diverter valve (102) allows the arriving water to flow through a second flow channel (“Flow channel B”) within the valve body (103) and out to the ablutionary installation (208) through the second outlet port (108).

8. The water saving system (100) of claim 5, wherein when the temperature of the water arriving from the preexisting pipeline system (202) to the diverter valve (102) is equal to or above the set specific temperature, the plunger (112c) of the thermostat element (112) extend its length to push the thermostat body (112a) in vertically downward direction to open a second opening (108c) of the second outlet port (108) and allow the water from the valve body (103) to flow out therefrom.

9. The water saving system (100) of claim 8, wherein the opening of the second opening (108c) of the second outlet port (108) by pushing the thermostat body (112a) in vertically downward direction is facilitated by compression of the spring (112d).

10. The water saving system (100) of claim 8, wherein the second opening (106c) is opened as a result of the movement of the cylinder (112a) attached to the thermostat body (12a).

11. The water saving system (100) of claim 1, wherein the ablutionary installation (208) comprises of a shower head, a faucet, and a handtap or similar outlets through which the user can access water flowing out of the second outlet port (108) of the diverter valve (102).

12. A diverter valve (102) adapted for saving water, comprising:
a valve body (103) having an inlet port (104), a first outlet port (106) with a first opening (106c) and a first member (106d), and a second outlet port (108) with a first opening (106c) and a first member (106d), wherein the inlet port (104) is in a fluid communication to a preexisting pipeline system (202) to draw water therefrom, the first outlet port (106) of the diverter valve (102) in fluid communication to an auxiliary tank (206), and the second outlet port (108) in fluid communication to an ablutionary installation (208);
a thermostat element (112) disposed within the valve body (103) perpendicularly aligned with respect to the first and second outlet ports (106,108); and
a temperature adjuster (110) rotatably configured over an end (113) opposite to the inlet port (104) of the valve body (103), wherein the temperature adjuster (110) enables a user to set a specific temperature based on which the diverter valve (102) would switch the flow of water arriving from the preexisting pipeline system (202) to either the first outlet port (106) for storage in the auxiliary tank (206), or the second outlet port (108) for delivery to the user through the ablutionary installation (208).

13. The diverter valve (102) of claim 12, wherein the thermostat element (112) further comprising:
a thermostat body (112a) wrapped by a spring (112d);
a plunger (112c) operationally configured on a top end of the thermostat body (112a) to either retract or extend based on the temperature of the water passing through the valve body (103); and
a cylinder (112b) configured on the top end of the thermostat body (112a) surrounding the plunger (112c) such as to move along with the movement of the thermostat body (112a).

14. The diverter valve (102) of claim 12, wherein the ablutionary installation (208) comprises of a shower head, a faucet, and a handtap or similar outlets through which the user can access water flowing out of the second outlet port (108) of the diverter valve (102).

15. The diverter valve (102) of claim 12, wherein when temperature of the water arriving from the preexisting pipeline system (202) to the diverter valve (102) is detected to be below the set specific temperature, the diverter valve (102) allows the arriving water to flow through a first flow channel (“Flow Channel A”) within the valve body (103) and out to the auxiliary tank (206) through a pipe (204) for storage.

16. The diverter valve (102) of claim 12, wherein when temperature of the water arriving from the preexisting pipeline system (202) to the diverter valve (102) is equal to or above the set specific temperature by the user, the diverter valve (102) allows the arriving water to flow through a second flow channel (“Flow channel B”) within the valve body (103) and out to the ablutionary installation (208) for delivery to the user.

17. The diverter valve (102) of claim 16, wherein when the temperature of the water arriving from the preexisting pipeline system (202) is detected to be equal to or above the set specific temperature, the plunger (112c) of the thermostat element (112) extend its length to push the thermostat body (112a) in vertically downward direction to open the second opening (108c) of the second outlet port (108) and allow the water from the valve body (103) to flow out therefrom.

18. The diverter valve (102) of claim 15, wherein when the temperature of the water arriving from the preexisting pipeline system (202) to the diverter valve (102) is detected to be below the specific temperature, the plunger (112c) of the thermostat element (112) retracts to push the thermostat body (112a) in vertically upward direction to open the first opening (106c) of the first outlet port (106) and allow the water from the valve body (103) to flow out therefrom.

19. The diverter valve (102) of claim 18, wherein the first opening (106c) is opened as a result of the movement of the cylinder (112a) attached to the thermostat body (112a) in parallel to the first and second members (106d,108d) in vertically upward direction.

20. The diverter valve (102) of claim 17, wherein the second opening (106c) is opened as a result of the movement of the cylinder (112a) attached to the thermostat body (112a) in parallel to the first and second members (106d,108d) in vertically downward direction.
